(19) United States
(12) Patent Application Publication
(10) Pub. No.: US 2017/0373863 A1
(43) Pub. Date: Dec. 28, 2017

(54) METHOD FOR MANAGING THE REPORTING OF THE PRESENCE OF A TERMINAL WITHIN A COMMUNICATIONS NETWORK

(71) Applicant: Orange, Paris (FR)

(72) Inventors: Ali-Amine Mouafik, Boulogne-Billancourt (FR); Sanaa El Moumouhi, Montrouge (FR)

(21) Appl. No.: 15/544,865

(22) PCT Filed: Jan. 19, 2016
(86) PCT No.: PCT/FR2016/050092

§ 371 Date: Jul. 19, 2017

(30) Foreign Application Priority Data
Jan. 20, 2015 (FR) 1550445

(51) Int. Cl. H04L 12/14; H04W 64/00; H04W 60/00

(52) U.S. Cl. CPC H04L 12/1407; H04W 60/00; H04W 64/00

(57) ABSTRACT

A method is disclosed of managing the reporting of the presence of a communications terminal in a communication network including a control rules application entity able to implement a presence reporting mechanism and a credits management entity configured to transmit a request for subscription to the presence reporting mechanism to the control rules application entity. The method includes verifying, during the establishment of a communication session between the terminal and a packet communication network, involving a control entity providing control rules to the control rules application entity, that the control entity is configured to trigger a subscription to the presence reporting mechanism with the control rules application entity. When the control entity is configured to trigger a subscription to the presence reporting mechanism, an indicator of intervention of the presence reporting mechanism is dispatched to the credits management entity, to inhibit a subscription to the mechanism by the credits management entity.

The invention relates to the general field of telecommunications. It relates more particularly to a method for managing the reporting of the presence of a terminal within a presence reporting area of a communications network.

The specification document “TS 23.203” of the 3GPP standards group, version 13.2.0, defines an architecture referred to as “PCC architecture” (for “Policy and Charging Control”) aimed at enabling a dynamic control of the network resources as a function of information collected by a control entity known as “PCRF entity” (for “Policy Control and Charging Rules Function”). This information is for example information associated with the network (e.g. type of radio access, addresses of gateways, client localization), associated with a subscriber (e.g. subscription information), or else associated with an application (e.g. type of application, type of media). The PCRF entity thus adapts and controls the use of the network resources as a function notably of services required by the subscriber and of his/her subscriber profile. For this purpose, the PCRF entity supplies to an entity for application of control rules, known as “PCEF entity”, control rules for a communication session between a terminal and a communications network via data packets. These control rules are commonly referred to as “PCC rules”.

The specification document “TS 23.401” of the 3GPP standards group, version 13.1.0, furthermore defines a procedure for reporting the presence within a presence reporting area (or PRA). This procedure aims to reduce the network traffic due to a change of location of a subscriber terminal by avoiding a systematic notification of this change to various entities of the network. According to this procedure, a change of location is only notified when the terminal enters or exits from a predefined presence reporting area consisting of one or more geographical areas. This procedure is able to be managed by the PCRF control entity or by an entity for managing subscriber credits, known as OCS (for “Online Charging System”) entity.

When this procedure is managed by the PCRF control entity, the latter determines, by means of subscription information of the subscriber, whether the communication session to be established requires the activation of the presence reporting. If such is the case, the PCRF control entity sends to the PCEF rules application entity a presence reporting area identifier associated with the subscriber, when the control rules are sent to this same entity. The identifier thus indicates to the PCEF rules application entity that the presence reporting must be activated, or in other words that the PCRF control entity wishes to be notified when the terminal enters or exits from the presence reporting area associated with the subscriber. In this case, the credit management entity OCS can only request from the PCEF rules application entity to be notified of a change of presence reporting area for the same area as the PCRF control entity. This notably allows a presence reporting area conflict to be avoided, which may for example affect the invoicing of the usages of the subscriber. When the PCRF control entity does not manage the presence reporting procedure, the credit management entity OCS may, on the other hand, manage it itself by dispatching a presence reporting area identifier, defined locally, to the PCEF rules application entity. The credit management entity OCS thus activates the presence reporting itself and indicates its desire to be notified when the terminal enters or exits from the presence reporting area identified by the identifier sent to the PCEF rules application entity.

The presence reporting procedure such as known from the prior art does however have drawbacks. In particular, it does not allow a presence reporting area conflict to be avoided when the presence reporting is only activated for certain time slots. In this case, when the time slot is changed, the PCRF control entity is indeed capable of activating the presence reporting for a presence reporting area associated with the subscriber, whereas the latter has already been activated by the credit management entity OCS for another presence reporting area.

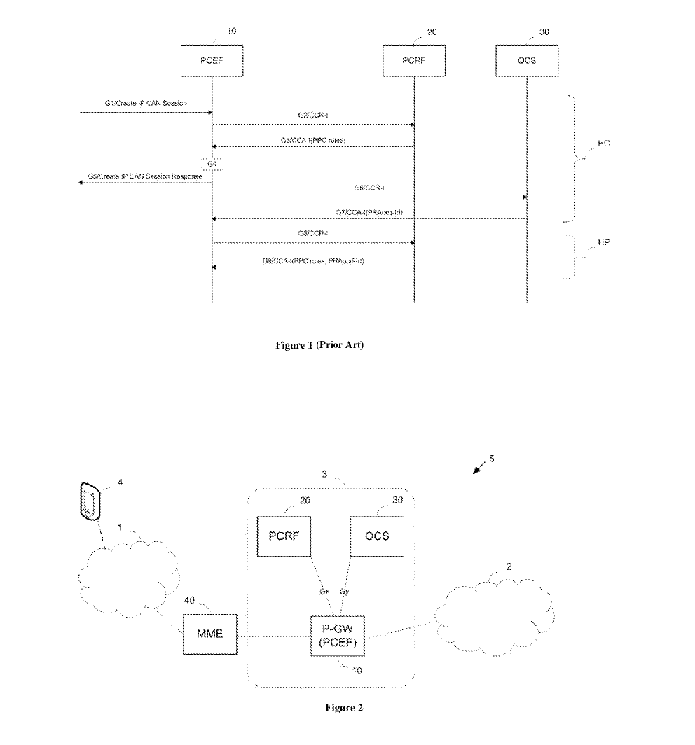

In order to better illustrate these drawbacks, reference is made to FIG. 1 which shows the steps of a method for managing the reporting of the presence of a terminal in a communications network according to the prior art.

This reporting management method is implemented by a PCEF rules application entity 10, a PCRF rules control entity 20 and a credit management entity OCS 30, according to the specification documents “TS 23.203” and “TS 23.401” of the 3GPP standards group.

The method is implemented during two phases: an HC phase corresponding to a time slot referred to as “off-peak hours” during which no request for subscription to a mechanism for presence reporting of the terminal is generated by the control entity 20, and an HP phase corresponding to a time slot referred to as “peak hours” during which the PCRF control entity 20 subscribes to the mechanism for presence reporting of the terminal. By way of example, the HC phase corresponds to the time slot going from 23 h to 20 h, and the HP phase corresponds to the time slot going from 20 h to 23 h. These time slots are for example predefined by the operator of the communications network.

The steps G1 to G7 take place during the first HC phase. The entities for rules application PCEF 10, for rules control PCRF 20 and for managing credits OCS 30 communicate with one another using for example the communications protocol Diameter such as provided in the RFC (for “Request For Comments”) 4006 document.

During a step G1, a PCEF rules application entity 10 receives a request for establishment of a communication session. The communication session is more precisely a session known as “IP CAN” (for “Internet Protocol Connectivity Access Network”) such as defined by the 3GPP standards group. This session represents an association between a terminal identified by an IPv4 (for “Internet Protocol version 4”) address or IPv6 (for “Internet Protocol version 6”) address and a packet communications network (or PDN for “Packet Data Network”) identified by an APN (for “Access Point Name”) identifier.

During a step G2, the PCEF rules application entity 10 sends a CCR-I (for “Credit Control Request-Initial”) message to a PCRF control entity 20 in order to obtain PCC control rules to be applied. The acquisition of the PCC control rules is initiated by the PCEF rules application entity 10 according to a mode known as “PULL”.

During a step G3, the PCRF rules control entity 20 responds to the rules application entity 10 by dispatching a CCA-I (for “Credit Control Answer-Initial”) reply message comprising the PCC control rules.

During a step G4, the PCEF rules application entity 10 stores these rules locally and applies them.

During a step G5, the PCEF rules application entity 10 sends a response for the attention of the terminal in order to indicate to it that the communication session IP CAN is established.

During a step G6, the PCEF rules application entity 10 determines, using the rules obtained at the step G3, that a session with the credit management entity 30 is to be opened. The PCEF rules application entity 10 then sends a CCR-I message to the credit management entity OCS 30. It should be highlighted here that this message does not comprise a presence reporting area identifier since no request for subscription to the mechanism for reporting the presence of the terminal is sent during the off-peak hours HC phase. The credit management entity OCS 30 receives the CCR-I message and determines that no mechanism for reporting the presence of the terminal has been activated owing to the absence of a presence reporting area identifier in the CCR-I message.

During a step G7, since the mechanism for reporting the presence of the terminal has not been activated by the PCRF rules control entity 20, the credit management entity 30 thus determines that it can subscribe to the mechanism for reporting the presence of the terminal. The credit management entity OCS 30 then sends a CCA-I reply message comprising an identifier PRAocs-Id of a presence reporting area for the terminal predefined in the credit management entity OCS 30. The reply message is, by way of example, sent at 19h55 just before the end of the off-peak hours HC phase.

Then, at 20 hrs, the peak hours HP phase begins During this HP phase, the PCRF rules control entity 20 can again subscribe to the mechanism for reporting the presence of the terminal. The steps G8 and G9 then take place during this HP phase.

When the HP phase begins at 20 hrs, one of the rules obtained by the PCEF rules application entity 10, at the step G3, indicates to the latter entity to send a request to the PCRF rules control entity 20 in order to obtain an update of the control rules to be applied. For this purpose, during a step G8, the PCEF rules application entity 10 sends a CCR-I (for “Credit Control Request-Initial”) message to the PCRF control entity 20 in order to obtain the new PCC control rules to be applied.

During a step G9, the PCRF rules control entity 20 responds to the rules application entity 10 by dispatching a CCA-I (for “Credit Control Answer-Initial”) reply message. Since this reply is generated during the peak hours HP phase, a set of parameters of the PCRF control entity 20 (e.g. control rule applied locally by the PCRF control entity 20) indicates to the latter entity to subscribe to the subscription mechanism for reporting the presence of the terminal. For this purpose, the CCA-I message sent comprises the new PCC control rules to be applied during the HP phase, together with an identifier PRApcf-Id of the presence reporting area for the terminal for which the PCRF control entity 20 wishes to subscribe to the presence reporting mechanism.

At this stage, the rules application entity then receives a second presence reporting area identifier PRApcf-Id from the PCRF control entity 20, which is added to the presence reporting area identifier PRAocs-Id of the terminal previously received from the credit management entity OCS 30 at the step G7.

No solution is thus provided for allowing the rules application entity to manage or prevent the presence reporting area conflict of the terminal occurring due to the receipt of identifiers of areas relating to subscriptions to the reporting mechanism for separate geographical areas.

One of the aims of the invention is to overcome the drawbacks of the prior art and/or to apply improvements to them.

According to a first aspect, the invention relates to a method for managing the reporting of the presence of a terminal within a communications network comprising a control rules application entity, designed to implement a mechanism for reporting the presence of the terminal within a presence reporting area of the network, and a credit management entity configured for transmitting a request for subscription to the mechanism for reporting the presence of the terminal to the control rules application entity, the method being characterized in that it comprises:

a verification, during a phase for establishing a communication session between the terminal and a packet communications network, involving a control entity supplying control rules to the control rules application entity, that the control entity is configured for triggering a subscription to the mechanism for reporting the presence of the terminal to the control rules application entity, and when the control entity is configured for triggering a subscription to the mechanism for reporting the presence of the terminal, the dispatching to the credit management entity of an indicator of support of the presence reporting mechanism by the control entity, designed to inhibit a subscription to the mechanism by the credit management entity.

It is recalled here that, in the presence reporting mechanism such as that known from the prior art, when the control entity does not subscribe to this mechanism, the credit management entity is authorized to subscribe to it for a presence reporting area defined locally to the latter entity. The absence of subscription of the control entity to the presence reporting mechanism does not however allow it to be determined whether this mechanism is supported and capable of being implemented later on by this entity. The credit management entity is thus able to subscribe to the presence reporting mechanism, for a given presence reporting area, whereas a subscription for another presence reporting area by the control entity is able to take place.

By virtue of the method, it is possible to verify that the control entity supports the mechanism for reporting the presence of the terminal, and to inform the credit management entity of this fact. The credit management entity is notified of this support of the reporting mechanism before the control entity has effectively subscribed to the presence reporting mechanism. This effective subscription to the presence reporting mechanism may furthermore happen either when the communication session is established or during the communication session once the latter has been established. The credit management entity, having been informed that the control entity is configured for triggering a subscription to the presence reporting mechanism, does not subscribe to the presence reporting mechanism. A presence reporting area conflict can thus be avoided. The later consequences (e.g. invoicing errors for the subscriber usages) of such an area conflict on the processing operations requiring a precise tracking of the localization of the terminal are also avoided.

According to one particular feature, the verification consists in verifying that at least one of the rules supplied by the control entity comprises a presence reporting area identifier associated with the communication session.

The method thus provides a criterion that is simple to implement for verifying the support of the presence reporting mechanism by the control entity.

Moreover, since the criterion used for the verification is implemented by analysis of control rules associated with the communication session, it is possible to verify a support of the presence reporting mechanism by subscriber.

Here again, there does not exist any limitation with regard to the time when the effective subscription to the presence reporting mechanism is triggered which may happen either when the communication session is established or during the communication session once the latter has been established.

According to one particular feature, the method furthermore comprises an establishment of a control session, at the moment of establishment of the communication session, between the control entity and the control rules application entity, and a negotiation of functions supported by the control entity and control rules application entity, the verification being carried out when the control session is established and consisting in verifying that at least one of the functions comprises a parameter indicating that the control entity is configured for triggering a subscription to the presence reporting mechanism.

The verification of the support of the presence reporting mechanism by the control entity at the time of the establishment of a control session with the rules application entity allows the control reporting mechanism to be globally configured in the control entity for all of the subscribers.

According to one particular feature, the method furthermore comprises, when the control entity and the credit management entity are respectively configured for triggering a subscription to the mechanism for reporting the presence of the terminal within a first presence reporting area of the network and within a second presence reporting area of the network:

a dispatching of an identifier of the first presence reporting area to the credit management entity;

a verification by the credit management entity that the identifier of the first area is identical to an identifier of the second presence reporting area;

the subscription of the credit management entity to the mechanism for reporting the presence of the terminal being inhibited when the first and second presence reporting areas are not verified as identical.

The dispatching of the identifier of the presence reporting area, for which the control entity is configured for triggering a subscription to the presence reporting mechanism, allows the credit management entity of the presence reporting area concerned by this subscription to be informed. The latter entity can thus advantageously only inhibit a subscription to the presence reporting mechanism for the presence reporting areas different from that for which the control entity has subscribed. The credit management entity can subscribe to the presence reporting mechanism for the same area as the control entity. A presence reporting area conflict can thus be avoided while at the same time allowing the credit management entity to be informed of a change of location of the terminal.

According to a second aspect, the invention relates to a control entity, designed to implement a mechanism for reporting the presence of a terminal within a presence reporting area of a communications network, comprising:

a connection module, arranged for establishing a control session with a control rules application entity;

a supply module, arranged for supplying control rules to the control rules application entity;

a verification module, arranged for verifying, during a phase for establishing a communication session between the terminal and a packet communications network, that the control entity is configured for triggering a subscription to the mechanism for reporting the presence of the terminal to the control rules application entity;

a dispatching module, activated when the control entity is configured for triggering a subscription to the mechanism for reporting the presence of the terminal, and arranged for dispatching to a credit management entity an indicator of support of the presence reporting mechanism by the control entity, designed to inhibit a subscription to the mechanism by the credit management entity.

According to one particular feature, the control entity furthermore comprises a functions negotiation module, activated when a control session is established with the control rules application entity, arranged for negotiating functions supported by the control and control rules application entities, the verification module being furthermore arranged for verifying, when the control session is established, that at least one of the functions comprises a parameter indicating that the control entity is configured for triggering a subscription to the presence reporting mechanism.

The advantages put forward for any one of the features of the presence reporting management method according to the first aspect are directly transposable to the control entity according to the second aspect.

According to a third aspect, the invention relates to a control rules application entity, comprising:

a connection module, arranged for establishing a control session with a control entity designed to implement a mechanism for reporting the presence of a terminal within a presence reporting area of a communications network;

a receiver module, arranged for receiving control rules from the control entity, a request for subscription to the presence reporting mechanism from the control entity, and an indicator of support of the presence reporting mechanism by the control entity, designed to inhibit a subscription to the mechanism by the credit management entity;

a dispatching module, arranged for dispatching the support indicator to the credit management entity.

According to one particular feature, the control rules application entity furthermore comprises a functions negotiation module, activated when a control session is established with the control entity, arranged for negotiating functions supported by said control rules application entities and control entity, at least one of the functions comprising a parameter indicating that the control entity is configured for triggering a subscription to the presence reporting mechanism.

The advantages put forward for any one of the features of the presence reporting management method according to the first aspect are directly transposable to the control rules application entity according to the third aspect.

According to a fourth aspect, the invention relates to a system for managing the reporting of the presence of a terminal within a presence reporting area of a communications network, comprising:

a control entity such as previously described;

a rules application entity such as previously described;

an entity for controlling a credit associated with the communication session.

According to a fifth aspect, the invention also relates to a program for a control entity, comprising program code instructions designed to control the execution of the steps of the method for managing the reporting of the presence of a terminal previously described, when said program is executed by said control entity and a recording medium readable by a control entity on which a program for a control entity is recorded.

According to a sixth aspect, the invention also relates to a program for a control rules application entity, comprising program code instructions designed to control the execution of the steps of the method for managing the reporting of the presence of a terminal previously described, when said program is executed by said control rules application entity and a recording medium readable by a control rules application entity on which a program for a control rules application entity is recorded.

The invention will be better understood with the aid of the following description of particular embodiments, with reference to the appended drawings in which, aside from FIG. 1 already commented relating to the prior art:

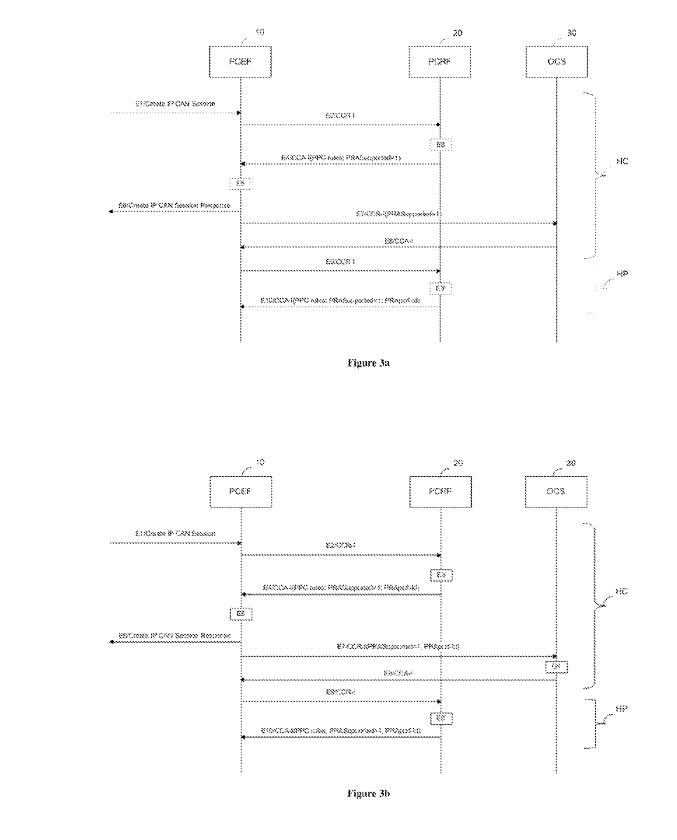

FIG. 2 shows steps of a method for managing the reporting of the presence of a terminal in a communications network according to the prior art;

FIGS. 3a to 3c show steps of a reporting management method according to a first particular embodiment;

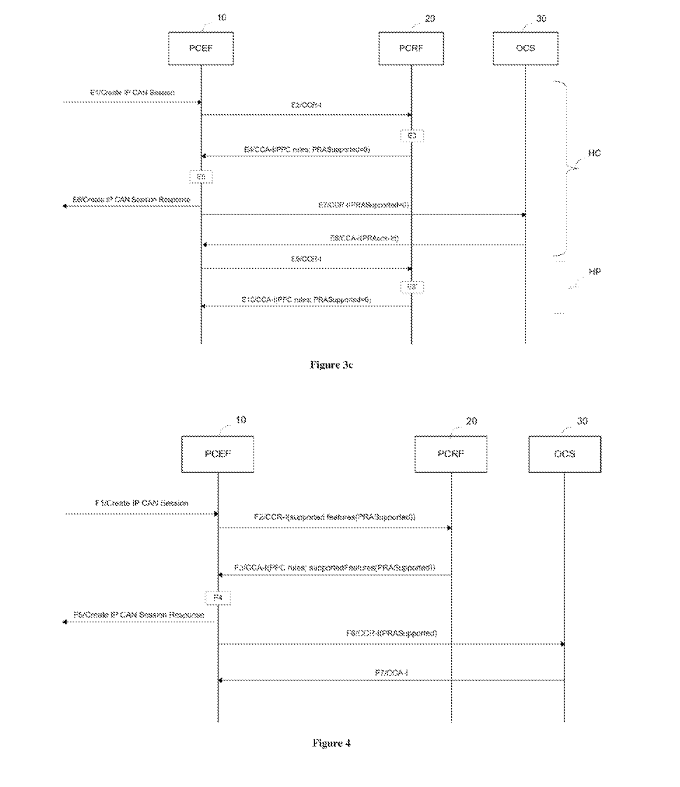

FIG. 4 shows steps of a reporting management method according to a second particular embodiment;

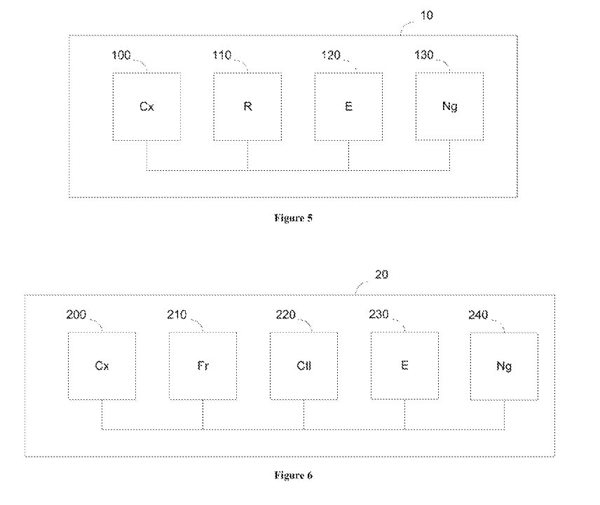

FIG. 5 shows a rules application entity according to one particular embodiment;

FIG. 6 shows a control entity according to one particular embodiment.

FIG. 2 shows a system 3 for managing the reporting of the presence of a terminal 4 within a presence reporting area of a communications network 5. This communications network 5 is, by way of example, an EPS (for “Evolved Packet System”) network. The terminal 4 accesses the communications network 5 via a mobile access network 1.

The system 3 more particularly allows a change of location, with respect to a presence reporting area, of the terminal 4 to be reported, for which terminal a communication session is established with a packet communications network 2. The change of location corresponds to an input or to an output of the terminal 4 in the presence reporting area associated with the terminal 4. This reporting area is typically a geographical area defined by one or more cells of the mobile network 1.

The system 3 is integrated into a PCC architecture and comprises a control entity 20, a rules application entity 10 and a credit management entity 30. The control entity 20 is for example a PCRF entity, the rules application entity 10 a PCEF entity and the credit management entity 30 an OCS entity such as described in the specification document “TS 23.203”. In the embodiment described, the PCEF entity is furthermore a module of an interconnection gateway P-GW (for “Packet Data Network-Gateway”).

Such as previously described, the control entity 20 collects information associated with the network, with a subscriber, or else associated with an application. The control entity 20 adapts and controls the usage of the network resources according to services required by the subscriber and to his/her subscriber profile, and sends for this purpose PCC control rules to the rules application entity 10.

When a communication session is opened between the terminal 4 and the packet communications network 2, the control rules application entity 10 opens a control session with the control entity 20 in order to obtain the control rules to be applied to the communication session. The rules application entity 10 transmits the features requested for the communication session to the control entity 20. Depending on these features and on the information that it has collected such as previously mentioned, the control entity 20 determines the control rules (quality of service, pricing, etc.) to be applied for the various services transported by the communication session and sends them to the rules application entity 10. In particular, if the control entity 20 determines that the terminal 4 is for example associated with a provision of services associated with a location of the terminal 4 within a particular geographical area, it sends a request to the rules application entity 10 for subscription to a mechanism for reporting the presence of the terminal 4 within a presence reporting area corresponding to this geographical area. The control entity 20 thus requests to be notified by the rules application entity 10 of the changes in location of the terminal 4 when the latter enters or exits from this presence reporting area. Similarly, when the rules application entity 10 determines, depending on control rules obtained from the control entity 20, that it is necessary to open a session with the credit management entity 30, the latter is also able to subscribe to the presence reporting mechanism, in order to be notified by the rules application entity 10 of the changes in location of the terminal 4 when the latter enters or exits from this presence reporting area.

The request for subscription to the presence reporting mechanism is subsequently transmitted to an entity for managing mobility 40, called MME (for “Mobility Management Entity”). The mobility management entity 40 is responsible for the management of the mobility procedures within the communications network 5. It notably stores the request for subscription to the presence reporting mechanism and associates it with the communication session. Each time that the terminal 4 enters or exits from the presence reporting area associated with it, the mobility management entity 40 updates the location of the terminal 4 and updates the communication session. The rules application entity 10 is thus informed of the new location of the terminal 4 and, in turn, informs the entities of the communications network 5 having subscribed to the mechanism for reporting the presence of the terminal 4. The rules application entity 10 is thus able to relay the information reporting the presence of the terminal 4 to the control entity 20 or else to the credit management entity 30.

The communications between the various entities are provided by means of interfaces defined by the 3GPP standards group, notably the interface Gy between the rules application entity 10 and the credit management entity 30, and the interface Gx between the rules application entity 10 and the control entity 20.

The system 3 has been described in an EPC communications network; it may however readily be adapted to other network architectures. By way of example, in one embodiment where the communications network is a UMTS (for “Universal Mobile Telecommunications System”) network, the system is adapted by implementing the rules application entity 10 in a GGSN (for “Gateway GPRS Support Node”) interconnection gateway. Alternatively, the rules application entity 10 may also be implemented by a dedicated device.

FIG. 3a shows steps of a reporting management method according to a first particular embodiment.

In a similar manner as for the reporting management method of the prior art described in relation with FIG. 1, the reporting management method is implemented by a PCEF rules application entity 10, a PCRF rules control entity 20 and a credit management entity OCS 30. The method is implemented over two phases: an HC phase corresponding to a time slot referred to as “off-peak hours” during which no request for subscription to a mechanism for reporting the presence of the terminal is generated by the control entity 20, and an HP phase corresponding to a time slot referred to as “peak hours” during which the PCRF control entity 20 subscribes to the mechanism for reporting the presence of the terminal. By way of example, the HC phase corresponds to the time slot going from 23 h to 20 h, and the HP phase corresponds to the time slot going from 20 h to 23 h. These time slots are for example predefined by the operator of the communications network.

The first HC phase comprises the steps E1 to E8. The PCEF rules application entity 10, PCRF rules control entity 20 and credit management entity OCS 30 communicate with one another using for example the communications protocol Diameter.

During a step E1, a PCEF rules application entity 10 receives a request for establishing a communication session. The communication session is an IP CAN session between a terminal identified by an IPv4 or IPv6 address and a packet communications network identified by an APN identifier.

During a step E2, the PCEF rules application entity 10 sends a CCR-I (for “Credit Control Request-Initial”) message to a PCRF rules control entity 20 in order to obtain PCC control rules to be applied. The obtaining of the PCC control rules is initiated by the PCEF rules application entity 10 according to a mode known as “PULL”.

In a step E3, the PCRF rules control entity 20 verifies, when the communication session is established between the terminal and the packet communications network, that it is configured for triggering a subscription to a mechanism for reporting the presence of the terminal to the PCEF rules application entity 10. For this purpose, the PCRF rules control entity 20 verifies that at least one of the control rules that it supplies comprises a presence reporting area identifier associated with the communication session.

During a step E4, after having verified that it is configured for triggering a subscription to the mechanism for reporting the presence of the terminal, the PCRF control entity 20 sends to the PCEF rules application entity 10 a CCA-I reply message comprising the PCC control rules and an indicator PRASupported of support of the presence reporting mechanism. This indicator is more particularly designed to inhibit a subscription to the mechanism for reporting the presence of the terminal by the credit management entity 30. In the embodiment described in relation with FIG. 3a, this indicator has the value 1 which indicates that the control entity 20 supports the presence reporting mechanism and is able to subscribe to this mechanism.

During a step E5, the PCEF rules application entity 10 stores the control rules locally and applies them.

During a step E6, the PCEF rules application entity 10 sends a response for the attention of the terminal in order to indicate to it that the communication session IP CAN is established.

During a step E7, the PCEF rules application entity 10 determines by means of the rules obtained at the step E4 that a session with the credit management entity 30 is to be opened. The PCEF rules application entity 10 then sends a CCR-I message comprising the indicator PRASupported to the credit management entity OCS 30. The credit management entity OCS 30 receives the CCR-I message and determines that, although no mechanism for reporting the presence of the terminal has been activated owing to the absence of a presence reporting area identifier in the CCR-I message, the PCRF rules control entity 20 nevertheless supports the reporting mechanism for the terminal, and that a subscription to this mechanism is planned by the PCRF rules control entity 20.

During a step E8, the credit management entity 30 having determined that a subscription of the PCRF rules control entity 20 to the presence reporting mechanism is already planned, does not send any request for subscription to the mechanism for reporting the presence of the terminal. The credit management entity OCS 30 thus sends a CCA-I reply message indicating no presence reporting area identifier for the terminal. The subscription to the presence reporting mechanism by the PCRF rules control entity 20 is thus anticipated in order to avoid the presence reporting area conflict described previously in relation with FIG. 1. The reply message is, by way of example, sent at 19h55 just before the end of the off-peak hours HC phase.

When the peak hours HP phase begins at 20 hrs, the PCRF rules control entity 20 can once more subscribe to the mechanism for reporting the presence of the terminal. One of the rules obtained by the PCEF rules application entity 10, at the step E3, indicates to the latter entity to send a request to the PCRF rules control entity 20 in order to obtain an update of the control rules to be applied. For this purpose, during a step E9, the PCEF rules application entity 10 sends a CCR-I message to the PCRF control entity 20 in order to obtain the new PCC control rules to be applied.

In a step E3′, the PCRF rules control entity 20 repeats the step for verification that it is configured for triggering a subscription to a mechanism for reporting the presence of the terminal to the PCEF rules application entity 10.

During a step E10, subsequent to this verification, the PCRF rules control entity 20 responds to the rules application entity 10 by dispatching a CCA-I reply message. Since this reply is generated during the peak hours HP phase, a set of parameters of the PCRF control entity 20 (e.g. control rule applied locally by the PCRF control entity 20) indicates to the latter entity to subscribe to the subscription mechanism for reporting the presence of the terminal. For this purpose, the CCA-I message sent comprises the new PCC control rules to be applied during the HP phase, together with an identifier PRApcf-Id of the presence reporting area for the terminal for which the PCRF control entity 20 wishes to subscribe to the presence reporting mechanism. The reply message furthermore comprises the indicator PRASupported. The PCEF rules application entity 10 may then determine, on the one hand, that the PCRF rules control entity 20 supports the presence reporting mechanism and, on the other hand, that the PCRF entity 10 is requesting a subscription to this mechanism for the presence reporting area with identifier PRAperf-Id. The PCEF rules application entity 10 thus receives a unique presence reporting area identifier PRApcf-Id. The presence reporting area conflict for the terminal described in relation with FIG. 1 is thus avoided.

FIG. 3b describes an embodiment similar to that described in relation with FIG. 3a. The steps E1 to E3, E5, E6, and E9 to E10 are identical to those described previously in relation with FIG. 3a. In this embodiment, the PCRF rules control entity 20 may subscribe to the mechanism for reporting the presence of the terminal during the off-peak hours HC phase.

Following the verification step E3, where the PCRF rules control entity 20 verifies that it is configured for triggering a subscription to a mechanism for reporting the presence of the terminal to the PCEF rules application entity 10, the PCRF rules control entity 20 triggers a subscription to the mechanism for reporting the presence of the terminal within a presence reporting area of the communications network. For this purpose, during a step E4, it sends to the credit management entity OCS 30, in addition to the indicator PRASupported of support of the presence reporting mechanism, an identifier PRAperf-Id of the presence reporting area for which it wishes to subscribe to the mechanism for reporting the presence of the terminal.

In a step E7, when the indicator of support of the presence reporting mechanism PRASupported is transmitted to the credit management entity OCS 30, the identifier PRAperf-Id is also sent with the CCR-I message. The credit management entity OCS 30 is thus informed of the presence reporting area for which the PCRF control entity 20 has subscribed to the presence reporting mechanism.

In a step G1, the credit management entity OCS 30 verifies that the identifier PRAperf-Id is identical to an identifier PRAocs-Id of a second presence reporting area parameterized in the credit management entity OCS 30. The identifier PRAocs-Id identifies, more particularly, a second presence reporting area for which a subscription of the credit management entity OCS 30 to the mechanism for reporting the presence of the terminal is parameterized. Since the identifiers PRAperf-Id and PRAocs-Id are not identical, the subscription of the credit management entity OCS 30 to the mechanism for reporting the presence of the terminal is inhibited.

During a step E8, since the subscription of the credit management entity OCS 30 to the mechanism for reporting the presence of the terminal has been inhibited, the credit management entity OCS 30 sends a CCA-I reply message not comprising a presence reporting area identifier for the terminal.

When the peak hours HP phase begins at 20 hrs, the PCRF rules control entity 20 may thus subscribe to the mechanism for reporting the presence of the terminal without causing any presence reporting area conflict. The subscription is carried out such as previously described in relation with FIG. 3a.

This embodiment thus has the advantage for the credit management entity of being able to avoid a presence reporting area conflict while at the same time authorizing a subscription of the credit management entity OCS 30 to the presence reporting mechanism when the presence reporting area for which the subscription is requested is identical to that subscribed by the PCRF control entity 20.

FIG. 3c describes the case where the mechanism for reporting the presence of the terminal is not supported by the PCRF rules control entity 20, under identical scheduling conditions respectively corresponding to the HC and HP phases.

During the verification step E3, the PCRF rules control entity 20 does not determine any configuration relating to the triggering of a subscription to a mechanism for reporting the presence of the terminal to the PCEF rules application entity 10. Then, at the step E4, the PCRF rules control entity 20 sends an indicator PRASupported valued at 0, indicating that the mechanism for reporting the presence of the terminal is not supported by the PCRF rules control entity 20.

During the step E7, this indicator is relayed by the PCEF rules application entity 10 to the credit management entity OCS 30. The latter is thus explicitly informed of the absence of support of the mechanism for reporting the presence of the terminal by the PCRF rules control entity 20.

During the step E8, the credit management entity OCS 30 may then subscribe to the mechanism for reporting the presence of the terminal by dispatching to the PCEF rules application entity 10 a CCA-I message comprising an identifier PRAocs-Id of presence reporting area, defined locally to the credit management entity OCS 30. The credit management entity OCS 30 is thus free to subscribe to the presence reporting mechanism, the latter mechanism not being supported by the PCRF rules control entity 20.

The others steps of the method implemented during the peak hours HP phase are identical to the embodiments described previously except for the fact that the support indicator PRASupported is valued at 0 in order to indicate that the mechanism for reporting the presence of the terminal is not supported by the PCRF rules control entity 20.

FIG. 4 shows steps of a reporting management method according to a second particular embodiment. As previously, the reporting management method is implemented by a PCEF rules application entity 10, a PCRF rules control entity 20 and a credit management entity OCS 30.

During a step F1, a PCEF rules application entity 10 receives a request for establishing a communication session between a terminal identified by an IPv4 or IPv6 address and a packet communications network identified by an APN identifier.

During the steps F2 and F3, the PCEF rules application entity 10 negotiates with the PCRF control entity 20 functions supported by each of the two entities. During this negotiation happening during the establishment of a control session between the PCEF rules application entity 10 and the PCRF rules control entity 20, the PCEF rules application entity 10 and PCRF rules control entity 20 respectively exchange with each other the functions that they support in a CCR-I message and in a CCA-I message. The PCEF rules application entity 10 then verifies that at least one of the functions negotiated comprises a parameter indicating that the PCRF control entity 20 is configured for triggering a subscription to the presence reporting mechanism. The CCA-I message furthermore comprises PCC control rules supplied by the PCRF rules control entity 20 to the PCEF rules application entity 10.

During a step F4, the PCEF rules application entity 10 stores the PCC control rules locally and applies them.

During a step F5, the PCEF rules application entity 10 sends a response for the attention of the terminal in order to indicate to it that the communication session IP CAN is established.

During a step F6, the PCEF rules application entity 10 determines by means of the rules obtained at the step E4 that a session with the credit management entity OCS 30 is to be opened. The PCEF rules application entity 10 then sends a CCR-I message comprising an indicator PRASupported to the credit management entity OCS 30. The credit management entity OCS 30 receives the CCR-I message and determines that, although no mechanism for reporting the presence of the terminal has been activated owing to the absence of a presence reporting area identifier in the CCR-I message, the PCRF rules control entity 20 nevertheless supports the reporting mechanism for the terminal, and that a subscription to this mechanism is planned by the PCRF rules control entity 20.

During a step F7, the credit management entity OCS 30 sends a CCA-I reply message not comprising any presence reporting area identifier, the subscription to the mechanism for reporting the presence of the terminal by the credit management entity OCS 30 being inhibited.

FIG. 5 shows a control rules application entity 10 according to one particular embodiment. The control rules application entity 10 comprises:

a connection module 100, arranged for establishing a control session with a control entity 20 designed to implement a mechanism for reporting the presence of a terminal within a presence reporting area of a communications network;

a receiver module 110, arranged for receiving control rules from the control entity 20, a request for subscription to the presence reporting mechanism from the control entity 20, and an indicator of support by the control entity 20 of the presence reporting mechanism, designed to inhibit a subscription to this mechanism by a credit management entity;

a dispatching module 120, arranged for dispatching the support indicator to the credit management entity.

In another embodiment, the control rules application entity 10 furthermore comprises a functions negotiation module 130, activated when a control session is established with the control entity 20, arranged for negotiating functions supported by the control rules application entity 10 and control entity 20, at least one of the functions comprising a parameter indicating that the control entity 20 is configured for triggering a subscription to the presence reporting mechanism.

FIG. 6 shows a control entity 20 according to one particular embodiment. The control entity 20 is designed to implement a mechanism for reporting the presence of a terminal within a presence reporting area of a communications network. It comprises:

a connection module 200, arranged for establishing a control session with a control rules application entity 10;

a supply module 210, arranged for supplying control rules to the control rules application entity 10;

a verification module 220, arranged for verifying, during a phase for establishing a communication session between the terminal and a packet communications network, that the control entity 20 is configured for triggering a subscription to the mechanism for reporting the presence of the terminal to the control rules application entity 10;

a dispatching module 230, activated when the control entity 20 is configured for triggering a subscription to the mechanism for reporting the presence of the terminal, and arranged for dispatching to a credit management entity 30 an indicator of support of the presence reporting mechanism by the control entity 20, designed to inhibit a subscription of the credit management entity 30 to said mechanism.

In another embodiment, the control entity 30 furthermore comprises a functions negotiation module 240, activated when a control session is established with the control rules application entity 10, arranged for negotiating functions supported by the control entity 20 and control rules application entity 10, the verification module 220 being furthermore arranged for verifying, when the control session is established, that at least one of the functions comprises a parameter indicating that said control entity 20 is configured for triggering a subscription to the presence reporting mechanism.

The invention is implemented by means of software and/or hardware components. In this respect, the term “module” may correspond in this document either to a software component or to a hardware component or to an assembly of hardware and/or software components, designed to implement a function or a set of functions, according to what has been previously described for the module in question.

A software component corresponds to one or more computer programs, one or more sub-programs of a program or, more generally speaking, to any element of a program or of a software application. Such a software component is stored in a memory then loaded and executed by a data processor of a physical entity and is capable of accessing the hardware resources of this physical entity (memories, recording media, communications buses, input/output electronic modules, user interfaces, etc.).

In the same way, a hardware component corresponds to any element of a hardware assembly. This may be a hardware component, programmable or otherwise, with or without integrated processor for the execution of software. This is for example an integrated circuit, a smart card, an electronic module for the execution of firmware, etc.

In one particular embodiment, the modules 100, 110, 120, and 130 are arranged for implementing the method for managing the reporting of the presence of a terminal previously described. These are preferably software modules comprising software instructions for executing the steps of the method for managing the reporting of the presence of a terminal previously described, implemented by a control rules application entity.

The invention therefore also relates to:
a program for a control rules application entity, comprising program code instructions designed to control the execution of the steps of the method for managing the reporting of the presence of a terminal previously described, when said program is executed by said control rules application entity;
a recording medium readable by a control rules application entity on which the program for a control rules application entity is recorded.

Similarly, the modules 200, 210, 220, 230 and 240 are arranged for implementing the method for managing the reporting of the presence of a terminal previously described. These are preferably software modules comprising software instructions for executing the steps of the method for managing the reporting of the presence of a terminal previously described, implemented by a control entity. The invention therefore also relates to:
a program for a control entity, comprising program code instructions designed to control the execution of the steps of the method for managing the reporting of the presence of a terminal previously described, when said program is executed by said control entity;
a recording medium readable by a control entity on which the program for a control entity is recorded.

The software modules may be stored in or transmitted by a data medium. The latter may be a hardware storage medium, for example a CD-ROM, a magnetic diskette or a hard disk, or else a dispatching medium such as an electrical, optical or radio signal, or a telecommunications network.

1. A method for managing the reporting of the presence of a communications terminal within a communications network comprising a control rules application entity, configured to implement a mechanism for reporting the presence of the terminal within a presence reporting area of the network, and a credit management entity configured for transmitting a request for subscription to the mechanism for reporting the presence of the terminal to the control rules application entity, the method comprising:
verifying, during a phase for establishing a communication session between the terminal and a packet communications network, involving a control entity supplying control rules to the control rules application entity, that the control entity is configured for triggering a subscription to the mechanism for reporting the presence of the terminal to the control rules application entity, and
when the control entity is configured for triggering a subscription to the mechanism for reporting the presence of the terminal, dispatching to the credit management entity an indicator of support of the presence reporting mechanism by the control entity, configured to inhibit a subscription to the mechanism by the credit management entity.

2. The method as claimed in claim 1, wherein the verification comprises verifying that at least one of the rules supplied by the control entity comprises a presence reporting area identifier associated with the communication session.

3. The method as claimed in claim 1, further comprising establishing a control session, at the moment of establishment of the communication session, between the control entity and the control rules application entity, and a negotiation of functions supported by the control entity and control rules application entity, the verification being carried out when the control session is established, and comprising verifying that at least one of the functions comprises a parameter indicating that the control entity is configured for triggering a subscription to the presence reporting mechanism.

4. The method as claimed in claim 1, further comprising, when the control entity and the credit management entity are respectively configured for triggering a subscription to the mechanism for reporting the presence of the terminal within a first presence reporting area of the network and within a second presence reporting area of the network:
dispatching an identifier of the first presence reporting area to the credit management entity; and
verifying by the credit management entity that the identifier of the first area is identical to an identifier of the second presence reporting area, the subscription of the credit management entity to the mechanism for reporting the presence of the terminal being inhibited when the first and second presence reporting areas are not verified as identical.

5. A control entity, configured to implement a mechanism for reporting the presence of a communications terminal within a presence reporting area of a communications network, the control entity configured to:
establish a control session with a control rules application entity;
supply control rules to the control rules application entity;
verify, during a phase for establishing a communication session between the terminal and a packet communications network, that the control entity is configured for triggering a subscription to the mechanism for reporting the presence of the terminal to the control rules application entity; and
when the control entity is configured for triggering a subscription to the mechanism for reporting the presence of the terminal, dispatch to a credit management entity an indicator of support of the presence reporting mechanism by the control entity, designed to inhibit a subscription of the credit management entity to the mechanism.

6. The entity as claimed in claim 5, further configured to, when a control session is established with the control rules application entity, negotiate functions supported by the control entity and control rules application entity, and verify, when the control session is established, that at least one of the functions comprises a parameter indicating that the control entity is configured for triggering a subscription to the presence reporting mechanism.

7. A control rules application entity, configured to:
establish a control session with a control entity designed to implement a mechanism for reporting the presence of a communications terminal within a presence reporting area of a communications network;
receive control rules from the control entity, a request for subscription to the presence reporting mechanism from the control entity, and an indicator of support of the presence reporting mechanism by the control entity, configured to inhibit a subscription to the mechanism by a credit management entity;
dispatch the indicator of support to the credit management entity.

8. The entity as claimed in claim 7, further configured to, when a control session is established with the control entity, negotiate functions supported by the control rules application entity and control entity, at least one of the functions comprising a parameter indicating that the control entity is configured for triggering a subscription to the presence reporting mechanism.

9. A system for managing the reporting of the presence of a communications terminal within a presence reporting area of a communications network, comprising:
the control entity of claim 5;
a rules application entity; and
an entity configured to control a credit associated with the communication session, the rules application entity configured to:
establish a control session with the control entity;
receive, from the control entity, control rules, a request for subscription to the presence reporting mechanism, and an indicator of support of the presence reporting mechanism, configured to inhibit a subscription to the mechanism by the credit management entity; and
dispatch the indicator of support to the credit management entity.

10. A control entity, having stored thereon program code instructions which, when the program code instructions are executed by a processor of the control entity, cause the control entity to perform the method of claim 1.

11. A rules application entity, having stored thereon program code instructions which, when the program code instructions are executed by a processor of the rules application entity, cause the rules application entity to perform the method of claim 1.

12. A non-transitory computer-readable medium having stored thereone instructions, which when executed by a processor of a control entity, cause the control entity to perform the method of claim 1.

13. A non-transitory computer-readable medium having stored thereone instructions, which when executed by a processor of a rules application entity, cause the rules application entity to perform the method of claim 1.
